(19) United States
(12) Patent Application Publication
(10) Pub. No.: US 2013/0049249 A1
(43) Pub. Date: Feb. 28, 2013

(54) METHOD FOR PRODUCING A WIND TURBINE ROTOR BLADE PART WITH A CARBON FIBER-REINFORCED MAIN SPAR CAP

(71) Applicants: Marco Frankowski, Ostseebad Wustrow (DE); Dirk Austinat, Jarmen (DE)

(72) Inventors: Marco Frankowski, Ostseebad Wustrow (DE); Dirk Austinat, Jarmen (DE)

(21) Appl. No.: 13/585,971

(22) Filed: Aug. 15, 2012

(30) Foreign Application Priority Data
Aug. 24, 2011 (EP) 11006906.9

(51) Int. Cl. B29C 45/14

(52) U.S. Cl. 264/102

(57) ABSTRACT

Method for producing a wind turbine rotor blade part with a carbon fiber-reinforced main spar cap. The method includes: inserting a layer of a first fibrous material into a mold, wherein the fibrous material extends over a first width, inserting a first distribution medium and a plurality of layers of a carbon fiber material into the mold above the first distribution medium, wherein the layers of the carbon fiber material extend over a second width smaller than the first width, so that connecting sections of the first fibrous material protrude beyond the carbon fiber material on both sides thereof, inserting a second distribution medium and arranging an extraction channel above the carbon fiber material, arranging sprue channels in the region of the connecting sections, closing the mold and extracting the air therefrom via the extraction channel and feeding liquid plastics material that hardens through the sprue channels.

### CROSS REFERENCE TO RELATED APPLICATION

This application claims priority of European patent application no. 11006906.9, filed Aug. 24, 2011, the entire content of which is incorporated herein by reference.

### FIELD OF THE INVENTION

The invention relates to a method for producing a wind turbine rotor blade part with a carbon fiber-reinforced main spar cap. Wind turbine rotor blades or parts thereof, for example half-shells, are usually produced from fiber-reinforced plastics materials. A combination of glass fibers with polyester resins or with epoxy resins is often used.

### BACKGROUND OF THE INVENTION

The publication EP 0 525 263 A1 discloses a vacuum infusion process for producing fiber-reinforced plastics parts. In the known process, a plurality of layers of a fibrous material are inserted into a mold. Below and above the layers of the fibrous material there are respectively distribution media separated from the layers of the fibrous material by further layers made of what are known as peel-off plies. At the underside of the mold, below the lower distribution medium, there is a sprue channel, and above the upper distribution medium there is an extraction channel. The airtight sealed mold is evacuated by way of the extraction channel, and a liquid plastics material is sucked through the sprue channel here. This material becomes distributed via the lower distribution medium over the entire area of the mold and completely penetrates the layers of the fibrous material. After the plastics material has hardened, the distribution media and the peel-off plies are removed from the fiber-reinforced plastic.

Document WO 2007/038930 A1 has disclosed another method for producing fiber-reinforced plastics parts. In said known process, a porous material is used as distribution medium and can enter into bonding with the plastics material infused. Once the plastic has hardened the distribution medium remains in the finished component. In particular, it can form a surface of the component.

United States patent application publication 2011/0164987 discloses a method for producing a half-shell of a wind turbine rotor blade. A vacuum infusion process is likewise involved. A particular feature is that the fibrous material used includes a proportion of at least 20% by volume of metal wires. The diameter of the metal wires is greater than that of the glass fibers or carbon fibers also used, and this feature is intended to accelerate the saturation of the fibrous material with the liquid plastics material.

An important factor for ideal strength of the fiber-reinforced component in all of the methods mentioned is that the fibrous material is completely saturated by the liquid plastics material and that no air inclusions form. Particularly when carbon fibers are used, the diameter of which is often substantially smaller than that of, for example, glass fibers, this raises considerable practical difficulties and often requires the use of low-viscosity plastics material as matrix material. This is particularly true when different fibrous materials have been combined in a single component, for example in wind turbine rotor blade parts with a carbon fiber-reinforced main spar cap, where these also have very large dimensions.

It has therefore been disclosed that carbon fiber-reinforced main spar caps for such wind turbine rotor blades can be manufactured in a first vacuum infusion process and then bonded with the associated rotor blade half-shells composed for example of glass fiber-reinforced plastics materials. Thus, the complete saturation of the carbon fiber material can be better controlled. However, the process is complicated and further difficulties can arise on bonding of the carbon spar cap to the half-shells.

### SUMMARY OF THE INVENTION

On the basis thereof, the object of the invention is to provide a method for the production a wind turbine rotor blade part with a carbon fiber-reinforced main spar cap and which is easier to execute and which dependably enables complete saturation of the carbon fiber material and fully satisfactory bonding to the other constituents of the wind turbine rotor blade part.

The method serves for producing a wind turbine rotor blade part with a carbon fiber-reinforced main spar cap and includes the following steps, the sequence of which can be varied at least to some extent:
providing a mold,
inserting at least one layer of a first fibrous material into the mold, wherein the first fibrous material extends over a first width,
inserting a first distribution medium into the mold,
inserting a plurality of layers of a carbon fiber material into the mold above the first distribution medium, wherein the layers of the carbon fiber material extend over a second width which is smaller than the first width, so that connecting sections of the first fibrous material protrude beyond the carbon fiber material on both sides of the carbon fiber material,
inserting a second distribution medium and arranging at least one extraction channel above the carbon fiber material,
arranging sprue channels in the region of the connecting sections,
closing the mold,
extracting the air from the mold through the at least one extraction channel and
feeding a liquid plastics material that hardens through the sprue channels.

The mold provided can have an inner surface which defines an exterior surface of the wind turbine rotor blade part. The length and width of the mold in essence correspond to the length and, respectively, the width of the wind turbine rotor blade part or are slightly larger. The length of the mold can, for example, be 20 m and the width can, for example, be 50 cm or more.

The first fibrous material inserted into the mold can, for example, be a glass fiber material. The first fibrous material can differ from the carbon fiber material, and specifically in respect of the material of which the fibers are composed, and/or in respect of the diameter and/or the lengths of the fibers and/or in respect of the orientation of the fibers. It extends over a first width which can in essence correspond to the width of the mold. The at least one layer of the first fibrous material can form an exterior surface of the wind turbine rotor blade part, and in particular can form a part of an external shell of the wind turbine rotor blade. There can be further materials arranged between the first fibrous material and the mold, and in particular the mold can have been waxed or can comprise another release means which permits removal of the wind turbine rotor blade part once the plastics material has hardened. It is also possible to use a gel coat or another material which coats the first fibrous material and/or which affects the surface properties of the wind turbine rotor blade part in a desired manner.

A first distribution medium is inserted into the mold, in addition to the at least one layer of the first fibrous material. The distribution medium can include a structure that is porous and/or open pored and/or that forms cavities or channels, in particular a uni- or multiaxial structure, which promotes rapid and uniform distribution of the liquid plastics material in the layer formed by the distribution medium. The first distribution medium can remain in the wind turbine rotor blade part once the plastics material has hardened. It can be penetrated and wetted by the liquid plastics material and enter into bonding therewith, in such a manner that the material layers adjacent to the distribution medium have been bonded firmly to one another once the plastics material has hardened.

Above the first distribution medium, a plurality of layers of a carbon fiber material are inserted into the mold. These can be inserted immediately above the first distribution medium. It is also possible to arrange further material layers, in particular the at least one layer of the first fibrous material, immediately below the layers of the carbon fiber material and thus between the first distribution medium and the plurality of layers of the carbon fiber material. The entirety of the layers of the carbon fiber material can form a carbon fiber-reinforced main spar cap of the wind turbine rotor blade part once the plastics material has hardened. The layers of the carbon fiber material extend over a second width which is smaller than the first width. In other words, the width of the main spar cap formed by the carbon fiber material is smaller than that of the layers of the first fibrous material arranged thereunder. The arrangement of said materials here is such that connecting sections of the first fibrous material protrude on both sides of the carbon fiber material or, respectively, of the main spar cap formed therefrom. These connecting sections serve to bond the wind turbine rotor blade part to other components of a rotor blade, in particular to further sections of an external shell which are arranged laterally with respect to the main spar cap.

Above the carbon fiber material, a second distribution medium is inserted and at least one extraction channel is arranged. In contrast to the first distribution medium, this distribution medium can optionally be removed from the wind turbine rotor blade part once the plastics material has hardened. To this end, by way of example a peel-off ply can be arranged between the carbon fiber material and the second distribution medium. As an alternative, the second distribution medium can be enclosed in a semipermeable membrane (VAP film). The semipermeable membrane is self-releasing, so that the second distribution medium can be removed together with the film once the material has hardened.

In the region of the connecting sections, sprue channels are arranged, in particular parallel to a longitudinal axis of the mold. The liquid plastics material infuses through these in the region of the connecting sections, in particular on both sides of the carbon fiber material.

The mold is closed so as to be airtight, for example with a vacuum film. To this end, the entire arrangement can be covered with the film and edges of the mold can be bonded in an airtight manner with the vacuum film. The air is then extracted from the mold through the at least one extraction channel, so that a vacuum or a markedly subatmospheric pressure is generated within the mold. Simultaneously or subsequently, a liquid plastics material that hardens is fed through the sprue channels in such a way that it infuses into the evacuated mold in the region of the connecting sections. The liquid plastics material can by way of example include a polyester resin and/or an epoxy resin. The feed can by way of example be achieved by connecting the sprue channels to a container containing the liquid plastics material, for example by way of a hose. The connection and the subatmospheric pressure prevailing within the mold then cause the plastics material to be sucked through the sprue channels and to pass into the interior of the mold.

With the arrangement of the individual material layers according to the invention, in particular of the first distribution medium arranged below the layers of the carbon fiber material, the liquid plastics material becomes distributed relatively rapidly below the carbon fiber material. From there, it saturates the carbon fiber material with an upward flow direction until it reaches the second distribution medium. Complete saturation of the carbon fiber material is thus promoted, as also is displacement of all air inclusions that may have been trapped in the carbon fiber material. A large-area flow front is achieved within the carbon fiber material, and the flow path to be traversed within the carbon fiber material is traversed in the direction of the thickness of the carbon fiber material, corresponding to the thickness of the carbon fiber-reinforced main spar cap. This thickness in such main spar caps is generally substantially smaller than the width of the main spar cap, which by way of example can be 40 cm or more. This flow direction minimizes the time needed for complete saturation of the carbon fiber material. Inclusions are effectively eliminated by virtue of the short flow paths and the resultant smaller flow resistance.

The method according to the invention necessarily simultaneously gives an optimal bond between the main spar cap and the layers of the first fibrous material located thereunder, because both are saturated with the plastics material in a single method step. Because a single infusion process can be used in this manner to produce the main spar cap and those parts of the external shell of the rotor blade that are formed by the layers of the first fibrous material, production time is moreover reduced.

The sequence of the stated method steps can, of course, be varied at least to some extent, and between the individual steps it is possible, of course, to execute further steps. By way of example, further material layers can be inserted into the mold. The fact that the plurality of layers of the carbon fiber material are inserted into the mold above the first distribution medium does not necessarily imply that the carbon fiber material lies directly on the first distribution material. Instead, there can be further layers arranged between the layers mentioned. Similar considerations apply to the arrangement of the second distribution medium and of the extraction channel above the carbon fiber material.

In one embodiment, the first distribution medium inserted into the mold extends at least over the second width. It can in particular conclude at its two sides flush with the carbon fiber material, or can protrude at one or at both sides beyond the carbon fiber material. As a result it is achieved that the liquid plastics material becomes rapidly and uniformly distributed under the entire width of the carbon fiber material.

In one embodiment, the first distribution medium is inserted into the mold above the at least one layer of the first fibrous material. It is therefore relatively close to the layers of the carbon fiber material.

In one embodiment, the first distribution medium is inserted into the mold below the at least one layer of the first fibrous material. It can, in particular, be inserted into the mold as the bottom layer, optionally above a gel coat, peel-off ply and/or other release means. This permits work on the surface of the hardened wind turbine rotor blade part without impairment of structurally significant layers. By way of example, irregularities in the surface can be removed by grinding without touching any of the layers of the first fibrous material.

In one embodiment, the flow resistance exerted by the first fibrous material and the first distribution medium with respect to the liquid plastics material is selected and adjusted appropriately for the flow resistance of the carbon fiber material so as to form a flow front which is in essence flat, extending horizontally over the second width, within the carbon fiber material. The flow resistance is decisive for the rate of spread of the plastics material, i.e. in particular the flow front formed by the plastics material as it spreads. It is determined by the structure of the first fibrous material, in particular by the diameter of the fibers used and arrangement of these and by the structure of the first distribution medium. The thickness of the distribution medium also affects the resultant flow rate. The first distribution medium serves specifically to distribute the liquid plastics material and therefore has by definition a relatively low flow resistance. The first fibrous material can likewise have relatively low flow resistance, for example if glass fibers with relatively large diameters are used and/or if a, for example, woven or braided, bi- or multidirectional arrangement is used. The relevant factors mentioned are selected in such a way as to establish relatively small flow resistance in the layers arranged below the carbon fiber material and in such a way that these layers are therefore saturated with the plastics material in a relatively short time. Because the diameter usually used for the carbon fibers is smaller and/or because the orientation of these fibers is in essence unidirectional in the longitudinal direction of the main spar cap, the flow resistance of the carbon fiber material is generally substantially greater than the flow resistance in the region of the other material layers. The flow front therefore spreads markedly slower within the carbon fiber material. When the flow resistances are appropriately adjusted to each other as claimed, a result of this is that the saturation of the carbon fiber material starting from the entire underside of the carbon fiber material begins in essence at the same point in time. Within the carbon fiber material, a flow front then forms which is in essence flat and extends horizontally over the second width. Uniform and complete saturation of the carbon fiber material is thus promoted.

In one embodiment, the flow resistance exerted by the first fibrous material and the first distribution medium with respect to the liquid plastics material, and the viscosity of the liquid plastics material, have been adjusted appropriately for one another in such a way that the first distribution medium and the at least one layer of the first fibrous material have been saturated completely with the liquid plastics material within 60 seconds or less after the first discharge of the liquid plastics material from the sprue channels. The saturation of these material layers can preferably take place even more rapidly, for example within 30 seconds, 20 seconds, 10 seconds or less. In contrast to these short periods, the saturation of the carbon fiber material takes substantially longer, for example more than 5 minutes, 10 minutes, 15 minutes, 20 minutes, 30 minutes, or more. The relatively slow saturation of the carbon fiber material therefore begins in the middle of the underside of the carbon fiber material, where it begins at the latest only a short time after saturation begins at the edges of the underside of the carbon fiber material. Within this short time, the flow front propagates only to a small extent upward within the carbon fiber material, for example by less than 5 mm, less than 2 mm or less than 1 mm. The flow front that forms within the carbon fiber material in this embodiment is therefore also essentially flat and extends horizontally over the second width. Again, uniform saturation of the carbon fiber material is thus promoted.

In one embodiment, the carbon fiber material does not protrude laterally beyond the first distribution medium. To this end, the first distribution medium has at least the second width. It can by way of example have been arranged centrally below the carbon fiber material. This arrangement of the first distribution medium is contributes to permitting the liquid plastics material to form a flow front which in essence starts at the same point in time from the entire underside of the carbon fiber material.

In one embodiment, on arrangement of the sprue channels in the region of the connecting sections outlet openings of the sprue channels are arranged above, or laterally with respect to, the connecting sections. The outlet openings can be arranged at a distance from the carbon fiber material. As a result it is achieved that the liquid plastics material passes from the connecting sections to the carbon fiber material. Premature development of a flow front, in particular in a lateral region of the carbon fiber material, is inhibited.

In one embodiment, a third distribution medium which extends as far as the first distribution medium is arranged above the connecting sections, and on arrangement of the sprue channels in the region of the connecting sections outlet openings of the sprue channels are arranged immediately adjacent to the third distribution medium. A peel-off ply can be arranged underneath the third distribution medium in such a manner that the third distribution medium can in turn be removed from the wind turbine component once the liquid plastics material has hardened. By virtue of the third distribution medium, introduction of the liquid plastics material in the region of the connecting sections is more uniform and covers a larger area. This method further promotes rapid and uniform saturation of the wind turbine rotor blade part, in particular of the first distribution medium and of the at least one layer of the first fibrous material, with the liquid plastics material.

In one embodiment, the thickness of the plurality of layers of the carbon fiber material is 20 mm or more. This is true at least in a longitudinal section of the wind turbine rotor blade part and corresponds to the thickness of the main spar cap, where this thickness can vary over the length of the main spar cap. In other longitudinal sections the thickness can by way of example be less than 1 mm, or up to 40 mm or more. The method is particularly suitable for manufacturing wind turbine components with relatively thick main spar caps. The thickness can also be 45 mm or more or 50 mm or more.

In one embodiment, a pressure plate is inserted into the moldabove the second distribution medium. The underside of the pressure plate can have a smooth surface, which is preferably essentially flat. This is uniformly pressed onto the arrangement of the different fibrous materials and distribution media by the vacuum generated in the mold. The pressure plate can be a part of a pressure piece into which the at least one extraction channel and/or the second distribution medium are integrated. This pressure piece or the pressure plate can, in particular, have the second width of the plurality of layers of the synthetic fiber material, or can be narrower. After the liquid plastics material has hardened, the pressure plate or the pressure piece can be removed from the wind turbine component, for example by using a peel-off ply arranged between pressure plate or pressure piece and the plurality of layers of the carbon fiber material or by using a semipermeable membrane (VAT film). Use of a pressure plate achieves a smooth surface on the upper side of the main spar cap and inhibits formation of corrugations or creases in the carbon fiber material. This is important for the strength of the main spar cap and in particular for problem-free bonding of the main spar cap to a strut arranged above the main spar cap and extending in the longitudinal direction of the rotor blade.

In one embodiment, on inserting the at least one layer of the first fibrous material a plurality of layers of the first fibrous material are inserted, wherein at least one of the layers has the first width and at least one further layer arranged above said layer has a third width which is smaller than the first width and greater than the second width, so that at least one of the connecting sections has a step. In particular, both connecting sections can have a step formed in this way. The stepped configuration of the connecting sections can facilitate, in the region of the connecting sections, the bonding of the wind turbine rotor blade part to external shell sections arranged laterally with respect thereto. The attached external shell sections can likewise be constructed from a plurality of material layers which overlap the step-shaped connecting sections in a complementary manner.

In one embodiment, the first distribution medium includes a textile distribution medium. The expression textile distribution medium means a flexible material which is composed of a composite of a plurality of fibers, in particular of glass fibers. It can in particular be a woven, a knit or a random fiber mat. Random fiber mats made of glass fibers are also called CSM mats (chopped stranded fiberglass mat). Because of the random orientation of the fibers, which can moreover be relatively short, mats of this type have relatively large cavities between the fibers and can therefore be saturated easily in different flow directions and give optimal distribution of the liquid plastics material. At the same time, in particular when glass fibers are used, random fiber mats of this type bond in an optimal manner to the liquid plastics material, so that a firm bonding of the adjacent material layers is achieved.

In one embodiment, the first distribution medium includes an electrically conductive material. The electrically conductive material can in particular be a metal, for example a braid made of steel wire and/or of copper wires, or can be a copper mesh. The first distribution medium can also combine a plurality of materials, for example a random fiber mat made of glass fibers with metal wires incorporated therein or with an adjacently arranged metal mesh, in particular made of copper. The first distribution medium can also be composed exclusively of the electrically conductive material, since by way of example a copper mesh or a braid made of metal fibers or of metal wires can by virtue of its structure provide sufficient distribution effect for the liquid plastics material, in particular if wires with relatively large diameter are used. Effective protection from lightning is integrated into the wind turbine rotor blade part by virtue of the electrically conductive material. This is done immediately on manufacture of the wind turbine rotor blade part, and no separate operation is therefore necessary. Furthermore, the lightning protection does not impair the strength of the part, and the lightning protection is inseparably connected to the wind turbine rotor blade part.

In one embodiment, at least one layer of an electrically nonconductive fibrous material is arranged between the electrically conductive material and the carbon fiber material. By way of example, a further layer of the first fibrous material can be involved here, in particular a layer made of glass fibers. Effective electrical insulation is achieved between the electrically conductive material and the likewise electrically conductive carbon spar cap. Damage to the carbon spar cap in the event of lightning strike can thus be avoided.

In one embodiment, the method disclosed hitherto is used for producing a half-shell of a wind turbine rotor blade. This process has the following steps:
producing a wind turbine rotor blade part with a carbon fiber-reinforced main spar cap by the method according to the invention,
removing the wind turbine rotor blade part from the mold,
inserting the wind turbine rotor blade part into a half-shell mold,
inserting a plurality of layers of a fibrous material into the half-shell mold at both sides of the wind turbine rotor blade part and at least partially onto the connecting sections,
closing the half-shell mold with a vacuum film,
infusing a liquid plastics material that hardens in a vacuum infusion process.

In the first step, a wind turbine rotor blade part is produced by the method disclosed above. In this connection, reference is made to the above disclosures.

The wind turbine rotor blade part thus manufactured is then removed from the mold and inserted into a half-shell mold. The half-shell mold can be a conventional mold in which a half-shell for a wind turbine rotor blade is manufactured. Half-shell molds of this type are used to produce the lower shells on the pressure side and the upper shells on the suction side of wind turbine rotor blades. An elongate section of the inner area of the half-shell mold can have the same shape as the mold used for producing the wind turbine rotor blade part, so that the prefabricated wind turbine rotor blade part with the carbon fiber-reinforced main spar cap can be inserted with precise fit into the half-shell mold. The at least one first layer of the wind turbine rotor blade part then forms a part of the exterior area of the half-shell to be manufactured and is essentially adjacent to the internal side of the half-shell mold.

In further method steps, a plurality of layers of a fibrous material are inserted into the half-shell mold at both sides of the wind turbine rotor blade part and at least partially onto the connecting sections. The first fibrous material, in particular glass fibers, can preferably be used for this purpose, thus producing a single-material connection to the connecting sections or to those parts of the external shell that are formed by the wind turbine rotor blade part. The plurality of layers of the fibrous material inserted into the half-shell mold form further sections of the half-shell to be manufactured, and these in essence run in the longitudinal direction of the rotor blade or of the half-shell mold.

The half-shell mold is then closed, in particular with a vacuum film. The film can be bonded with edges of the half-shell mold in an airtight manner and likewise to upper/lateral edges of the prefabricated wind turbine rotor blade part. As an alternative, the entire wind turbine rotor blade part can be covered with a vacuum film.

In a last step, a liquid plastics material that hardens is infused in a vacuum infusion process. Suitable processes are in principle by way of example the vacuum infusion processes described at the beginning. The liquid plastics material that hardens, which preferably is the same as the plastic material used for producing the wind turbine rotor blade part, is thus uniformly distributed in the mold and uniformly saturates the layers of the fibrous material inserted into the half-shell mold. In particular, it reaches the immediate vicinity of the connecting sections of the wind turbine rotor blade part, and the layers of the fibrous material inserted into the half-shell mold are thus bonded firmly and durably to the wind turbine rotor blade part.

Half-shells for wind turbine rotor blades can be produced particularly securely and dependably in the manner described. The process is easy to control, and in essence the conventional production techniques and production equipment can be used for complete production of the half-shells and thereafter.

### BRIEF DESCRIPTION OF THE DRAWINGS

The invention will now be described with reference to the drawings wherein:

FIG. 1 is a greatly simplified schematic diagram of a wind turbine rotor blade part produced by the method according to the invention, on insertion into a half-shell mold; and,

FIG. 2 is a simplified diagram of the cross section of a wind turbine rotor blade part in a mold.

### DESCRIPTION OF THE PREFERRED EMBODIMENTS OF THE INVENTION

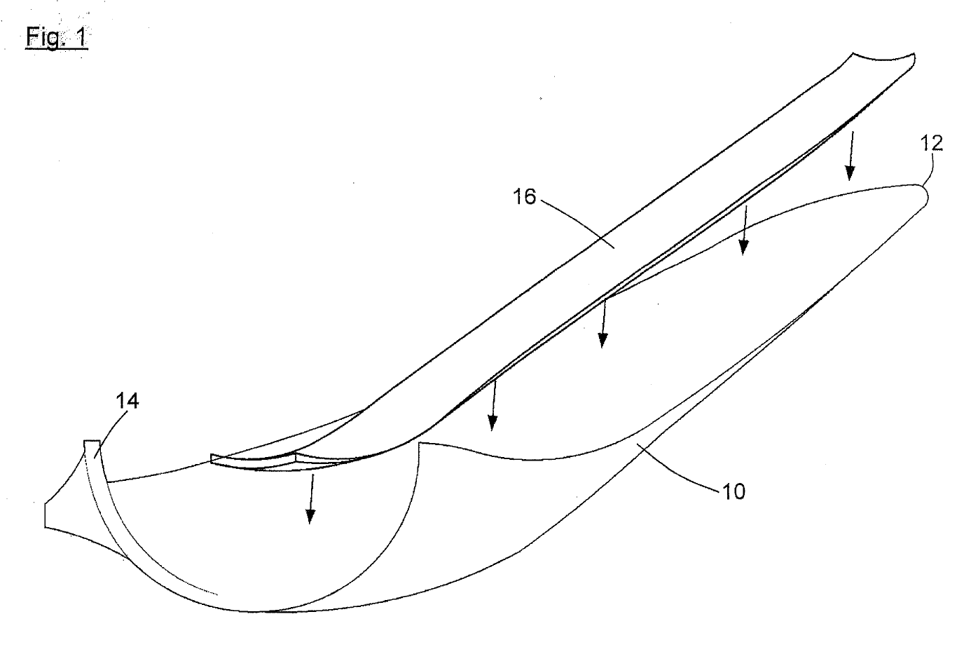

In FIG. 1 a half-shell mold 10 with an end 12 at the blade tip and an end 14 at the blade root can be seen. The cross section of the end 14 of the half-shell mold 10 at the blade root forms a semicircle. The total length of the half-shell mold 10 is by way of example 40 m or more, 50 m or more or even 60 m or more. In these large wind turbine rotor blades, it is often advisable to use carbon fiber-reinforced main spar caps, for reasons of strength and of weight.

FIG. 1 illustrates how a wind turbine rotor blade part 16 manufactured in accordance with the method of the invention is placed into the half-shell mold 10. The wind turbine rotor blade part 16 extends approximately over the entire length of the half-shell mold 10, but has a smaller width, measured in the direction of the depth of the profile. Along its frontal and rear edges running in a longitudinal direction, the wind turbine rotor blade part 16 has laminar connecting sections not shown in FIG. 1. These connecting sections can also be present at that end of the wind turbine rotor blade part 16 that faces toward the end 12 at the blade tip in the half-shell mold 10, that is along the curved edge shown at the top right-hand side of FIG. 1, and also at that, likewise curved, end of the wind turbine rotor blade part 16 that faces toward the end 14 at the blade root in the half-shell mold 10, formed by the edge facing toward the observer.

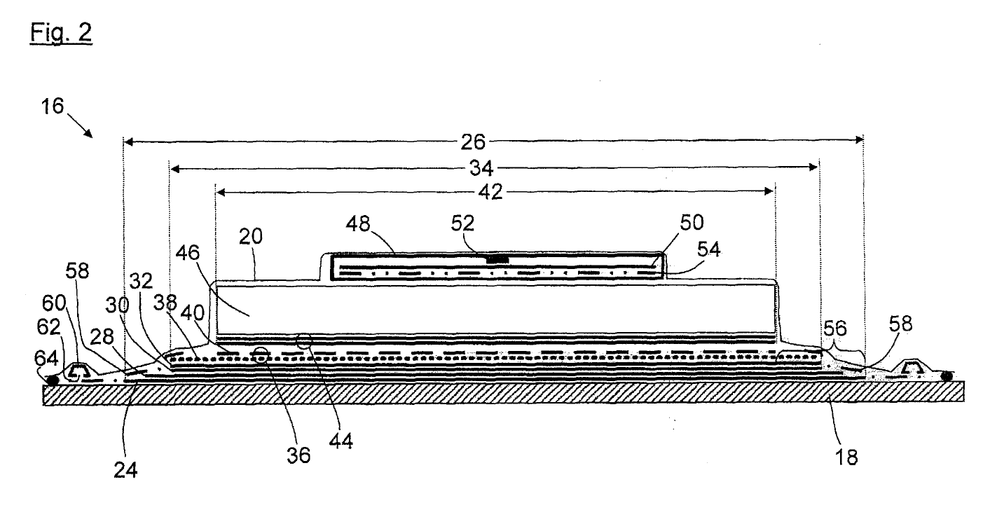

Further details of the wind turbine rotor blade part 16 can be more easily seen from FIG. 2. FIG. 2 shows a cross section of the manufacture of the wind turbine rotor blade part 16 in a mold 18 used for this purpose. FIG. 2 shows said mold 18 as even, but actually it has curvature corresponding to the exterior shape of the wind turbine rotor blade part 16 to be manufactured. FIG. 2 shows the condition of the wind turbine rotor blade part 16 once the different material layers have been inserted into the mold, the mold has been covered with a vacuum film 20 and the mold has been evacuated by way of an extraction channel 52, prior to feed of a liquid plastics material. In this condition, the following individual elements are present in the mold 18.

On the external side of the blade in the mold 18 there are a total of four layers of a first fibrous material, in the example bidirectional glass fiber textile, these layers being shown as continuous lines. Prior to insertion of these layers of the first fibrous material, the mold 18 was provided with a release means which permits easy removal of the finished wind turbine rotor blade part from the mold 18 once the plastics material has hardened.

The bottom layer 24 of the first fibrous material has a first width 26, which in the example is 60 cm. The second layer 28 of the first fibrous material, arranged thereover, is somewhat narrower. A third layer 30 and a fourth layer 32 of the first fibrous material have been arranged thereabove. The third and fourth layer 30, 32 each have a third width 34, which is smaller than the first width 26 and the width, not indicated by any reference sign, of the second layer 28. Thus, a step is formed between the third/fourth layer 32, 34 and the second layer 28, and also between the second layer 28 and the first layer 24, there is therefore in each case a step.

A first distribution medium 36 is arranged above the fourth layer 32 of the first fibrous material. The first distribution medium 36 includes a textile distribution medium in the form of a random fiber mat 38 made of glass fibers which extends over the entire width of the first distribution medium 36, namely over the third width 34. The first distribution medium 36 moreover includes an electrically conductive material, in the example taking the form of a copper mesh 40 arranged above the random fiber mat 38. The copper mesh 40 has a second width 42, which is smaller than the third width 34 and in the example is about 40 cm.

Two further layers 44 of the first fibrous material, arranged above the copper mesh 40, also have the second width 42. These layers 44 form an insulation layer between the copper mesh 40 and the plurality of layers of a carbon fiber material 46 arranged above the two layers 44 of the first fibrous material. The carbon fiber material 46 likewise has the second width 42. It is composed of carbon fibers with smaller diameter than the glass fibers of the first fibrous material and with unidirectional fiber orientation running essentially in the longitudinal direction of the wind turbine rotor blade part 16. The total thickness of the carbon fiber material 46 is about 50 mm.

Above the carbon fiber material 46 there is a pressure piece 48. This includes a pressure plate 50 with a lower area which is essentially flat. The width of the pressure plate 50 and of the pressure piece 48 is somewhat smaller than the second width 42. The pressure piece 48 moreover has an extraction channel arranged above the pressure plate 50. Below the extraction channel 52, the pressure plate 50 has openings, not shown, which connect the extraction channel 52 to a second distribution medium 54 arranged below the pressure plate 50. The second distribution medium 54 is likewise associated with the pressure piece 48 and in essence lies on the carbon fiber material 46, but a suitable release means, for example a peel-off ply and/or a semipermeable membrane, is arranged between the second distribution medium 54 and the carbon fiber material 46. FIG. 2 does not show this. The pressure piece can be completely enclosed by the semipermeable membrane. In a second variant, not shown, the membrane can also cover the entire structure. The membrane here is narrower than the vacuum film 20.

The sections protruding laterally beyond the second width 42 of the carbon fiber material 46 and belonging to the first fibrous material of the bottom layer 24, to the second layer 28, to the third layer 32 and to the fourth layer 34 form connecting sections 56. The connecting sections 56 are arranged at both sides of the main spar cap formed by the carbon fiber material 46, each have a width of about 10 cm and extend in the longitudinal direction of the wind turbine rotor blade part 16 essentially over the entire length thereof.

The connecting sections 56 are partially covered by a third distribution medium 58, shown as a dot-dash line in the figure and arranged above the connecting sections 58 and laterally with respect thereto. It extends as far as the first distribution medium 36 and partially overlaps the random fiber mat 38 of the first distribution medium 36. It moreover extends over the steps of the connecting sections 56 formed by the different layers 24, 28, 30, 32 of the first fibrous material and extends laterally beyond the first width 26 of the bottom layer 24 of the first fibrous material, where it in essence lies directly on the mold 18. A suitable release means, in particular a peel-off ply, can be arranged below the third distribution medium 58. FIG. 2 does not show this. It enables the removal of the third distribution medium once the liquid plastics material has hardened.

For infusing the liquid plastics material, there are sprue channels 60 above the third distribution medium 58 on both sides of the mold 18, and these have outlet openings 62. The outlet openings 62 point downward in the figure, so that the liquid plastics material emerging from said outlet openings 62 therefore passes directly onto the third distribution medium 58 and spreads therein.

The vacuum film 20 previously mentioned covers the entire arrangement inclusive of the pressure piece 48 and of the sprue channels 60, and is bonded in airtight manner at both sides to the mold 18 respectively by way of a seal 64.

Within the mold 18 closed by the vacuum film 20, a vacuum or a markedly subatmospheric pressure is generated via extraction of the air by way of the extraction channel 52. The extraction moreover takes place over a relatively large area through distribution by way of the second distribution medium 54 within the pressure piece 48.

The infusion of the liquid plastics material takes place by way of the sprue channels 60. From there, the liquid plastics material passes by way of the outlet openings 62 into the third distribution medium 58 and becomes further distributed within the different layers 24, 28, 30, 32 of the first fibrous material and within the random fiber mat 38 and the copper mesh 40 of the first distribution medium 36. This distribution procedure proceeds very rapidly, for example within 20 seconds or less, because the flow resistance of these material layers is relatively small. The two layers 44 of the first plastic material arranged above the first distribution medium 36 are also very rapidly saturated. The flow front that forms is therefore in essence flat, arranged horizontally, and saturates the carbon fiber material 46 uniformly and with an upward flow direction. This saturation procedure takes substantially longer, for example 15 minutes or more.

It is understood that the foregoing description is that of the preferred embodiments of the invention and that various changes and modifications may be made thereto without departing from the spirit and scope of the invention as defined in the appended claims.

### LIST OF REFERENCE CHARACTERS USED

10 half-shell mold
12 end at the blade tip
14 end at the blade root
16 wind turbine rotor blade part
18 mold
20 vacuum film
24 bottom layer of the first fibrous material
26 first width
28 second layer of the first fibrous material
30 third layer of the first fibrous material
32 fourth layer of the first fibrous material
34 third width
36 first distribution medium
38 random fiber mat
40 copper mesh
42 second width
44 further layers of the first fibrous material
46 carbon fiber material
48 pressure piece
50 pressure plate
52 extraction channel
54 second distribution medium
56 connecting section
58 third distribution medium
60 sprue channel
62 outlet opening
64 seal

What is claimed is:

1. A method for making a wind turbine rotor blade part having a carbon fiber-reinforced main spar cap; said method comprising the steps of:
providing a mold;
inserting at least one layer of a first fibrous material into the mold wherein the first fibrous material extends over a first width;
inserting a first distribution medium into the mold;
inserting a plurality of layers of a carbon fiber material into the mold above the first distribution medium, wherein the layers of the carbon fiber material extend over a second width which is smaller than the first width, so that connecting sections of the first fibrous material protrude beyond the carbon fiber material on both sides of the carbon fiber material;
inserting a second distribution medium into the mold;
arranging at least one extraction channel above the carbon fiber material;
arranging sprue channels in the region of the connecting sections;
closing the mold;
extracting the air from the mold through the at least one extraction channel; and,
feeding a liquid plastics material that hardens through the sprue channels.

2. The method of claim 1, wherein the first distribution medium inserted into the mold extends at least over the second width.

3. The method of claim 1, wherein the first distribution medium is inserted into the mold above the at least one layer of the first fibrous material.

4. The method of claim 1, wherein the first distribution medium is inserted into the mold below the at least one layer of the first fibrous material.

5. The method of claim 1, wherein the flow resistance exerted by the first fibrous material and the first distribution medium with respect to the liquid plastics material is selected and adjusted appropriately for the flow resistance of the carbon fiber material in such a manner so as to form a flow front, which is essentially flat and extends horizontally over the second width, within the carbon fiber material.

6. The method of claim 1, wherein the flow resistance exerted by the first fibrous material and the first distribution medium with respect to the liquid plastics material, and the viscosity of the liquid plastics material, have been adjusted appropriately for one another in such a manner that the first distribution medium and the at least one layer of the first fibrous material are saturated completely with the liquid plastics material within 60 seconds or less after the first discharge of the liquid plastics material from the sprue channels.

7. The method of claim 1, wherein the carbon fiber material does not protrude laterally beyond the first distribution medium.

8. The method of claim 1, wherein on arrangement of the sprue channels in the region of the connecting sections outlet openings of the sprue channels are arranged above, or laterally with respect to, the connecting sections.

9. The method of claim 1, wherein above the connecting sections a third distribution medium is arranged which extends as far as the first distribution medium, and on arrangement of the sprue channels in the region of the connecting sections outlet openings of the sprue channels are arranged immediately adjacent to the third distribution medium.

10. The method of claim 1, wherein the thickness of the plurality of layers of the carbon fiber material is 20 mm or more.

11. The method of claim 1, wherein a pressure plate is inserted into the mold above the second distribution medium.

12. The method of claim 1, wherein on inserting the at least one layer of the first fibrous material a plurality of layers of the first fibrous material are inserted, wherein at least one of the layers has the first width and at least one further layer arranged above said layer has a third width which is smaller than the first width and greater than the second width, so that at least one of the connecting sections has a step.

13. The method of claim 1, wherein the first distribution medium includes a textile distribution medium.

14. The method of claim 1, wherein the first distribution medium includes an electrically conductive material.

15. The method of claim 14, wherein at least one layer of an electrically nonconductive fibrous material is arranged between the electrically conductive material and the carbon fiber material.

16. A method for producing a half-shell of a wind turbine rotor blade comprising the steps of:
providing a mold;
inserting at least one layer of a first fibrous material into the mold wherein the first fibrous material extends over a first width;
inserting a first distribution medium into the mold;
inserting a plurality of layers of a carbon fiber material into the mold above the first distribution medium, wherein the layers of the carbon fiber material extend over a second width which is smaller than the first width, so that connecting sections of the first fibrous material protrude beyond the carbon fiber material on both sides of the carbon fiber material;
inserting a second distribution medium into the mold;
arranging at least one extraction channel above the carbon fiber material;
arranging sprue channels in the region of the connecting sections;
closing the mold;
extracting the air from the mold through the at least one extraction channel;
feeding a liquid plastics material that hardens through the sprue channels;
removing the wind turbine rotor blade part from the mold;
inserting the wind turbine rotor blade part into a half-shell mold;
inserting a plurality of layers of a fibrous material into the half-shell mold at both sides of the wind turbine rotor blade part and at least partially onto the connecting sections;
closing the half-shell mold; and,
infusing a liquid plastics material that hardens in a vacuum infusion process.
